(19) United States
(12) Patent Application Publication
(10) Pub. No.: US 2009/0094063 A1
(43) Pub. Date: Apr. 9, 2009

(54) DISPLAY AND METHOD FOR MEDICAL PROCEDURE SELECTION

(75) Inventor: Colleen M. Ennett, White Plains, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/282,777

(22) PCT Filed: Mar. 12, 2007
(86) PCT No.: PCT/IB2007/050830

§ 371 Date: Sep. 12, 2008

Related U.S. Application Data
(60) Provisional application No. 60/781,864, filed on Mar. 13, 2006.

(51) Int. Cl. G06F 17/00; G06Q 50/00

(52) U.S. Cl. 705/3; 705/7; 705/2; 705/8; 707/4; 707/E17.016; 707/E17.014

(57) ABSTRACT

A display system and method for displaying information to a clinician when selecting the next appropriate diagnostic test or therapeutic procedure to order for a patient are provided. The system assists the clinician in selecting the next step based on the information the clinician hopes to gain from the test or the result of the treatment. The system will present general and patient-specific information about the procedure to assist the clinician's selection. The system includes a user interface configured for entering desired resultant information of a procedure; a processor configured to determine at least one result code from the entered desired resultant information from a database associating result codes to resultant information; the processor configured to determine at least one procedure matching the at least one result code; and a display device for presenting the determined at least one procedure.

The present disclosure relates generally to data processing and decision systems, and more particularly, to a display system and method for assisting a clinician in selecting a procedure to be performed on a patient.

Limited financial resources and increasing emphasis on primary care in a managed care environment are driving medical care delivery to become more efficient and cost-effective without sacrificing quality. One major approach to achieving the goals of efficiency and quality is through the standardization of care for specific diseases. Care standardization efforts have included development of care maps, critical pathways, and care guidelines.

Clinical decision support systems typically attempt to recommend next tests or procedures to a clinician based on a set of rules. However, in some cases, the clinician knows what type of information he/she would like from a diagnostic test, but is not sure which test is the best to discover this information. Such knowledge would empower the referring clinician when interacting with specialists such as radiologists or nuclear medicine physicians.

Generally, clinicians reason by generating a list of differential diagnoses based on the patient's signs and symptoms, systematically testing the hypotheses to account for clinical data, and ruling out diseases from this list. For example, a clinician tackles a problem from the point of view, “I want to know the extent of myocardial ischemia. Which tests will provide this information?” The resulting list of tests that measure myocardial perfusion, which indicates the extent of myocardial ischemia, would include single-photon emission computed tomography (SPECT), positron emission tomography (PET), contrast echocardiography, and contrast-enhanced magnetic resonance imaging (MRI). However, decision support systems do not always operate in the same way that clinicians perform medical reasoning. Conventional decision support systems are often focused on strictly following guidelines or rules, which are aimed at the average patient and as such can be ambiguous. These systems tend to simply list all tests available for treating the condition at, for example, each stage of the guideline, leaving it to the clinician to recall what information each test provides. For experts, this may not be a problem. However, for subexperts (e.g., seasoned physicians working outside their own specialty area), this can be difficult because they are not exposed to this information on a regular basis. When the method of information presentation is incongruent with the clinician's thought process, it can impede clinical workflow, or even be counterproductive. Incompatibility with clinical workflow can lead to the rejection of a clinical decision support system.

Therefore, a need exists for techniques for assisting a clinician in selecting a procedure based on the desired results or resultant information derived from the procedure. Furthermore, these techniques and/or systems employing such techniques should be upgradeable to easily incorporate new and developing technologies which could provide the resultant information desired by the clinician.

A display system and method for displaying information to a clinician when selecting the next appropriate diagnostic test or therapeutic procedure to order for a patient are provided. The system will present general and patient-specific information about the procedure to assist the clinician's selection.

The decision support system and method of the present disclosure will assist clinicians in selecting the diagnostic test based on the information that the clinician hopes to discover from the test, e.g., extent of myocardial ischemia. This system tackles this problem in the same way that doctors approach the problem, based on the expected or resultant information to be gained from the test. In addition, the system provides the clinician with general and patient-specific data about the procedure to assist in the selection of the optimal procedure for the current patient.

In another embodiment of the present disclosure, a method could be used for providing therapy options. A care provider could enter into the system a desired result or the current diagnosis, and get back an ordered list of treatment options. This list would either directly supply or link to information about the various choices.

According to one aspect of the present disclosure, a computer implemented method for selecting a procedure is provided. The method includes the steps receiving an entry of desired resultant information of a procedure; determining at least one result code from the entered desired resultant information; determining at least one procedure matching the at least one result code; and presenting the determined at least one procedure.

In another aspect of the present disclosure, a system for selecting a procedure is provided including a user interface configured for entering desired resultant information of a procedure; a processor configured to determine at least one result code from the entered desired resultant information from a database associating result codes to resultant information; the processor configured to determine at least one procedure matching the at least one result code; and a display device for presenting the determined at least one procedure.

In a further aspect, a program storage device readable by a machine, tangibly embodying a program of instructions executable by the machine to perform method steps for selecting a procedure is provided, the method steps including receiving an entry of desired resultant information of a procedure; determining at least one result code from the entered desired resultant information; determining at least one procedure matching the at least one result code; and presenting the determined at least one procedure.

The above and other aspects, features, and advantages of the present disclosure will become more apparent in light of the following detailed description when taken in conjunction with the accompanying drawings in which:

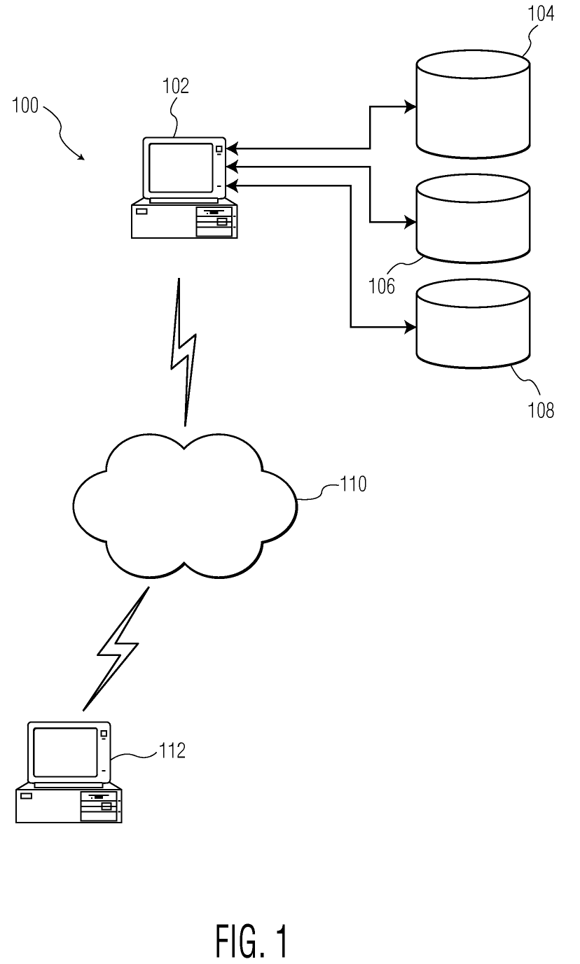

FIG. 1 is a block diagram of a system for assisting a clinician in selecting a procedure based on resultant information to be gained from the procedure in accordance with the present disclosure;

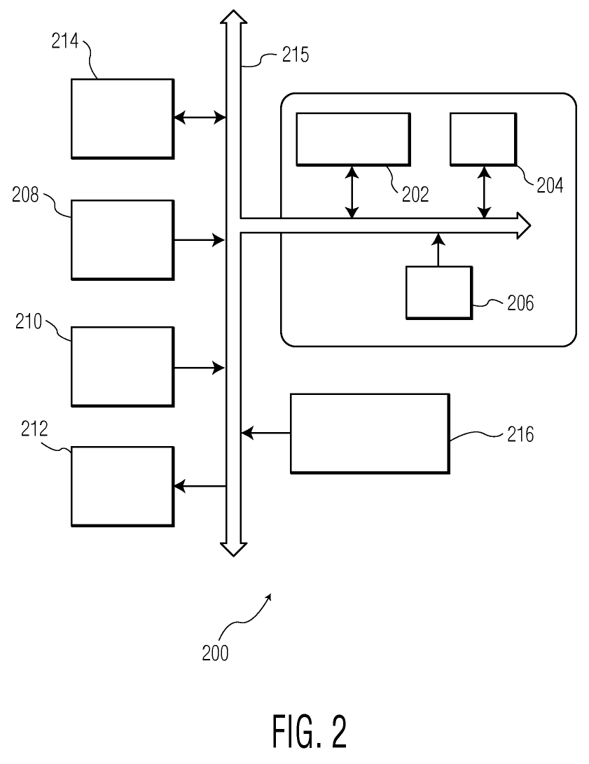

FIG. 2 is an exemplary computer for use in the system shown in FIG. 1;

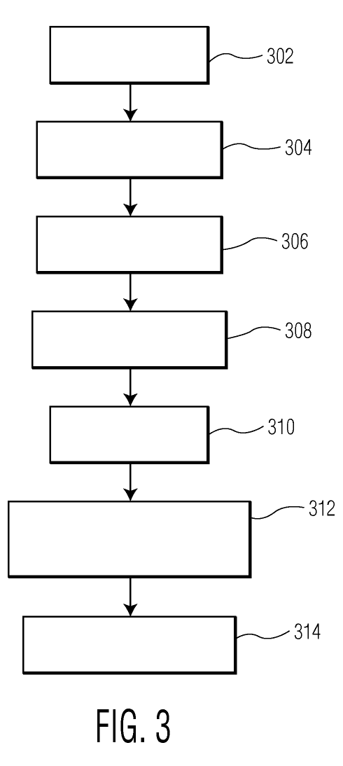

FIG. 3 is a flow chart illustrating a method for assisting a clinician in selecting a procedure based on resultant information; and

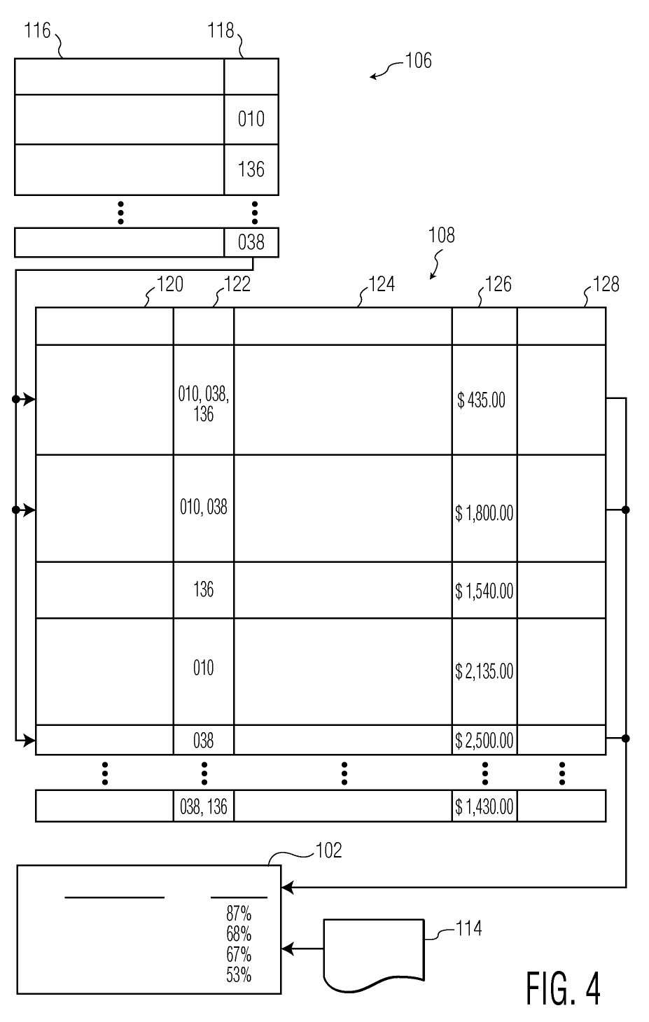

FIG. 4 is a flow diagram of how the system interacts with the various databases in assisting a clinician in selection of a procedure.

Preferred embodiments of the present disclosure will be described hereinbelow with reference to the accompanying drawings. In the following description, well-known functions or constructions are not described in detail to avoid obscuring the present disclosure in unnecessary detail.

A display system and method for displaying information to a clinician when selecting the next appropriate diagnostic test or therapeutic procedure to order for a patient are provided. The system and method presents clinicians with a list of information they may desire that is relevant to the patient's signs, symptoms and medical history, or alternatively, the clinicians may use a free-form text box to describe the information they are looking for, e.g., the expected or resultant information to be gained from a procedure. The system presents at least one option that provides the desired information or achieves the desired therapeutic goal. In addition, the system provides procedure-specific information such as invasiveness, risks, contraindications, limitations (e.g., for certain patient groups like diabetics), sensitivity and specificity statistics for a patient population with similar characteristics to the current patient, cost, reimbursement, time required to perform the test, earliest possible time to receive results, etc. to assist in the selection of the most appropriate procedure. Furthermore, the system provides general information about the procedure such as costs associated, location of equipment required to perform the procedure, etc.

Referring to FIG. 1, an overall system 100 diagram according to the present disclosure is illustrated. The system 100 includes a procedure selection system 102 configured for assisting a clinician in selecting an appropriate procedure for a patient. As will be described in more detail below, the procedure selection system 102 will determine and present to a user, e.g., a clinician, an appropriate procedure for obtaining desired information or generating a desired result by interacting with a plurality of databases: a patient record database 104, a result database 106 and a procedure database 108. The patient database 104 includes at least one record for each patient under care and will include, but not limited to, demographic data (e.g., age, gender, weight, height), medical history (e.g., clinical, therapeutic and diagnostic events, comorbidities, previously prescribed medications, allergies), vital signs (e.g., heart rate, respiratory rate, mean arterial blood pressure, blood glucose), administration of medications (e.g., date, time, dose, frequency), test results (e.g., electrocardiogram testing, imaging, blood test), and treatment results (e.g., surgical procedure, radiation treatment, medical treatment). The result database 106 will include a plurality of records associating a desired result or resultant information, e.g., extent of myocardial ischemia, to a code or identifier. The procedure database 108 will include a plurality of records each of which will include, but not limited to, a name of the procedure, associated result codes indicating what outcomes or information result from the procedure, possible contraindications for a patient, the cost associated with the procedure, a location where the procedure is to be performed, etc. A procedure in the procedure database 108 may have more than one result code associated with it. It is to be appreciated that the databases 104, 106 and 108 may reside on system 102 or may be located remotely and communicate to the procedure selection system over a network 110. Furthermore, the system 100 may include a ordering/scheduling system 112 for generating work orders after a procedure has been selected.

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine comprising any suitable architecture such as personal computer, a workstation or server. Referring to FIG. 2, preferably, the machine 200 is implemented on a computer platform having hardware such as one or more central processing units (CPU) 202, a random access memory (RAM) 204, a read only memory (ROM) 206 and input/output (I/O) interface(s) such as a keyboard 208, cursor control device 210 (e.g., a mouse or joystick) and display device 212. A data storage device 214, e.g., a hard drive, optical media, etc, is provided for storing application programs, databases, etc. A system bus 215 couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system.

In addition, various other peripheral devices may be connected to the computer platform by various interfaces and bus structures, such a parallel port, serial port or universal serial bus (USB). Other peripheral devices may include additional storage devices and a printer. A communication device 216, e.g., a network interface card (NIC), modem, WiFi card, etc., may also be provided to enable communication in a networked environment.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The computer 200 may operate in a networked environment using logical connections to one or more remote computers. The remote computer may be a personal computer, a server, a router, a network PC, a peer device or other common network node, and typically includes many or all of the elements described above relative to the computer. It is to be appreciated that the network may be a local area network (LAN), wide area network (WAN), the Internet or any known network that couples a plurality of computers to enable various modes of communication via network messages. For example, the system may be a intranet including a single server and multiple personal computers housed within a single facility, or alternatively, multiple servers with multiple personal computers located in various geographic locations.

An exemplary embodiment in accordance with the present disclosure will now be described in relation to FIGS. 3 and 4.

Initially, in step 302, a clinician will enter into the procedure selection system 102 via a user interface a desired result or resulting information they would like to study regarding a patient. The resultant information of interest may be for example “extent of myocardial ischemia,” “assessment of left ventricular function,” or “assessment of prognosis of coronary artery disease.” For the purposes of this illustrative example, assume a clinician desires to observe the extent of myocardial ischemia of the patient.

The entry step may be performed via a free-form text box where the clinician enters terms, keywords, a natural language phrase or the like. Alternatively, when the system is used in conjunction with a clinical decision system, a list of possible results or resultant information may be presented to the clinician via the display device 212 based on where the patient is along the clinical or prescribed guideline, e.g., based on a current step in the clinical guideline. For example, based on where the patient is along the clinical guideline, a clinician may want to study the results of particular procedures to confirm if a patient is progressing. The system of the present disclosure will present procedures to a clinician that will let them obtain the proper information to update the patient's prognosis.

After entering or selecting the desired result, the system 102 will receive the entry and determine the desired result code from database 106 (step 304). As illustrated in FIG. 4, result database 106 will include a plurality of records where each record includes a result field 116 associated with a code field 118. The determining of the result code may be performed by matching the user entry with terms in the result field 116 or by any conventional search engine or database search function as is known in the art.

The result database 106 may be populated with a unique coding system associating codes or identifiers, e.g., alpha-numeric codes, to resultant information. Alternatively, the result database may be populated with codes from existing coding systems, where the existing coding systems are modified to include associations or references to resultant information. Coding systems in common use in hospitals include Current Procedural Terminology (CPT), International Classification of Diseases (ICD), Diagnosis-Related Groups (DRG), Logical Observations Identifiers Names and Codes (LOINC), Unified Medical Language System (UMLS) and Systematized Nomenclature of Medicine (SNOMED). Other coding systems include International Classification of Primary Care (ICPC), Diagnostic and Statistical Manual of Mental Disorders (DSM), Read Clinical Codes, Gabrieli Medical Nomenclature, North American Nursing Diagnosis Association (NANDA) codes, Nursing Outcomes Classification (NOC), the Georgetown Home Health Care Classification (HHCC), Omaha System, Generalised Architecture for Languages Encyclopedias and Nomenclatures in Medicine (GALEN), National Drug Codes (NDC), World Health Organization (WHO) Drug Dictionary and the Anatomical-Therapeutic-Chemical (ATC) Index.

Once the result code has been determined, in this example code 038, the system 102 will access the procedure database 108 to determine which records match the result code (step 306). Each record of the procedure database 108 will include at least a procedure field 120, a code field 122, a contraindications field 124, a cost of procedure field 126 and/or a location of where the procedure is to be performed field 128. It is to be appreciated other fields may be included and associated with a particular procedure. In the example, at least four procedures match the result code that will provide the clinician with the desired resultant information: contrast echocardiography, contrast-enhanced MRI, PET and SPECT. At this point, the system 102 may present to the clinician the procedure options via display device 212 (step 308). In one embodiment, the system will display only the contents of the procedure field 120 to the clinician. In a further embodiment, the system will display the contents of any combination of the fields available in the procedure database 108.

It is to be appreciated that the procedure database 108 may be continuously updated as new procedures are developed, and therefore, introduce new procedures to achieve the desired result as they become available. As new procedures become available, a corresponding new record will be added to the procedure database having at least the code field 122 populated with codes or identifiers from the result database 106. For example, in one embodiment, the system may help to integrate molecular imaging and molecular medicine into clinical practice. Most clinicians are unaware of the expanding applications associated with molecular imaging and molecular medicine, and will continue to use only conventional approaches for many years to come. The system of the present disclosure can introduce these new options in a non-threatening manner alongside conventional technologies that may assist with the faster integration of these technologies into regular clinical practice. For example, as new procedures are added, the available options presented to the clinician for a previously used query will grow in number. Newly presented options may include links, e.g. hyperlinks, to other information such as background material, cases studies, white papers, web sites, etc. The clinician will be able to access the linked information from the display device via the communication device coupling the selection system 102 to various databases storing the information and/or to the Internet for accessing web sites containing the information.

In a further embodiment, the system will interact with an electronic medical record (EMR) of a patient to score or weight the possible procedures to best match the procedure to the particular patient. In step 310, the system 102 will retrieve an EMR 114 from database 104. The system 102 will determine if the test or procedures selected are compatible with the patient based on the patient's condition, allergies, vital signs, etc. (step 312). In this step, the system may eliminate certain possible procedures and only present the remaining possible procedures to the clinician.

Furthermore, the system 102 may further score the possible procedures based on cost associated with the procedure, location of equipment, contraindications, invasiveness, risks, limitations (e.g., for certain patient groups like diabetics), sensitivity and specificity statistics for a patient population with similar characteristics to the current patient, reimbursement, time required to perform the test, earliest possible time to receive results, etc. The scoring system may include predefined rules determined by the institution, e.g., hospital, housing the procedure selection system 100 or may allow the clinician to assign weights or importance to certain factors in determining the score. Once the possible procedures are scored, the procedures will be presented to the clinician in order from most favorable to least favorable as shown in FIG. 4.

In a further embodiment, the system 100 includes a ordering/scheduling system 112 configured to generate work orders for the various procedures and route the work orders to the appropriate personnel for performing the procedures. After the possible procedures are presented to the clinician via the display device 212 of the procedure selection system 102, the clinician may order the procedure to be performed by clicking on the desired procedure via the cursor control device 210. In one embodiment, a network message requesting the procedure to be performed will be transmitted over the network 110 to the ordering/scheduling system 112. A confirmation receipt may be transmitted back to the procedure selection system 102 to inform the clinician the procedure has been ordered. In another embodiment, a client application will open on the procedure selection system 102 and access the ordering/scheduling system 112. A work order template will open and certain fields may be prepopulated with information from the procedure selection system 102, e.g., name of patient, vitals signs, etc. The clinician will be able to select a preferred time and location of the procedure.

While the present disclosure has been shown and described with reference to certain preferred embodiments thereof, it will be understood by those skilled in the art that various changes in form and detail may be made therein without departing from the spirit and scope of the disclosure as defined by the appended claims.

1. A computer implemented method for selecting a procedure, the method comprising the steps:
receiving an entry of desired resultant information of a procedure;
determining at least one result code from the entered desired resultant information;
determining at least one procedure matching the at least one result code; and
presenting the determined at least one procedure.

2. The method as in claim 1, wherein the presenting step includes presenting general and patient-specific data about the at least one procedure to assist in selecting an optimal procedure for the patient.

3. The method as in claim 1, wherein the receiving step includes:
presenting a plurality of possible desired resultant information based on a current step of a patient clinical guidelines for a patient; and
selecting at least one desired resultant information from the plurality of possible desired resultant information.

4. The method as in claim 1, wherein a plurality of procedures match the at least one result code, further comprising the step scoring each of the plurality of determined procedures to assist in selecting an optimal procedure for a current patient.

5. The method as in claim 4, wherein the score for each of the determined procedures is based on cost associated with the procedure, location of equipment, contraindications, invasiveness, risks, limitations, sensitivity and specificity statistics for a patient population with similar characteristics to the current patient, reimbursement, time required to perform the test or earliest possible time to receive results.

6. The method as in claim 1, further comprising the steps:
retrieving an electronic medical record of a current patient from a patient database; and
determining if the at least one determined procedure is compatible with the current patient.

7. The method as in claim 1, wherein a plurality of procedures match the at least one result code, further comprising the steps:
retrieving an electronic medical record of a current patient from a patient database;
determining if each of the plurality of procedures is compatible with the current patient; and
presenting the compatible procedures from the plurality of determined procedures.

8. The method as in claim 1, further comprising the steps selecting one procedure of the at least one procedure and scheduling the selected procedure to be performed.

9. The method as in claim 1, further comprising the step of linking further information about the at least one procedure to the presented at least one procedure.

10. A system for selecting a procedure comprising:
a user interface configured for entering desired resultant information of a procedure;
a processor configured to determine at least one result code from the entered desired resultant information from a database associating result codes to resultant information;
the processor configured to determine at least one procedure matching the at least one result code; and
a display device for presenting the determined at least one procedure.

11. The system as in claim 10, wherein the processor is configured to determine a plurality of possible desired resultant information based on a current step of a patient clinical guidelines for a patient and the display device is configured for presenting the plurality of possible desired resultant information for selection by a user.

12. The system as in claim 10, wherein a plurality of procedures match the at least one result code and the processor is configured to score each of the plurality of determined procedures to assist in selecting an optimal procedure for a current patient.

13. The system as in claim 12, wherein the score for each of the determined procedures is based on cost associated with the procedure, location of equipment, contraindications, invasiveness, risks, limitations, sensitivity and specificity statistics for a patient population with similar characteristics to the current patient, reimbursement, time required to perform the test or earliest possible time to receive results.

14. The system as in claim 10, wherein the processor is configured to retrieve an electronic medical record of a current patient from a patient database and to determine if the at least one determined procedure is compatible with the current patient.

15. The system as in claim 10, wherein the user interface is configured for selecting one of the at least one procedure.

16. The system as in claim 15, further comprising a scheduling system configured to schedule the selected procedure to be performed.

17. The system as in claim 10, wherein the processor is configured to link further information about the at least one procedure to the presented at least one procedure and further comprising a communication device configured to access the linked information.

18. The system as in claim 10, wherein the processor determines the at least one procedure by accessing a procedure database, each record of the procedure database including a procedure field associated with a result code field.

19. The system as in claim 18, wherein each record of the procedure database further includes at least a contraindications field, a cost of procedure field and a location of where the procedure is to be performed field.

20. A program storage device readable by a machine, tangibly embodying a program of instructions executable by the machine to perform method steps for selecting a procedure, the method steps comprising:
receiving an entry of desired resultant information of a procedure;
determining at least one result code from the entered desired resultant information;
determining at least one procedure matching the at least one result code; and
presenting the determined at least one procedure.
